(19) United States
(12) Patent Application Publication
(10) Pub. No.: US 2010/0070428 A1
(43) Pub. Date: Mar. 18, 2010

(54) METHODS AND APPARATUS FOR PRODUCING A STOCK INDEX

(76) Inventor: Jesse L. Stamer, Winnetka, IL (US)

Correspondence Address: K&L Gates LLP, P.O. Box 1135, CHICAGO, IL, 60690, US

(21) Appl. No.: 12/555,594

(22) Filed: Sep. 8, 2009

Related U.S. Application Data
(60) Provisional application No. 61/095,174, filed on Sep. 8, 2008.

(51) Int. Cl. G06Q 40/00

(52) U.S. Cl. 705/36 R

(57) ABSTRACT

The present disclosure provides a system that produces a stock index by dynamically including the top X % of stocks based on float weighted capitalization in a new index. For example, the top 50% of stocks from a particular set of stocks (e.g., all of the stocks listed on a particular exchange) based on each stock's float weighted capitalization may be include in the index. As the overall list of stocks and/or the float weighted capitalizations change over time, the index may be automatically updated.

### PRIORITY CLAIM

This application claims the benefit of U.S. Provisional Patent Application No. 61/095,174, filed Sep. 8, 2008, entitled “A Method of Creating a Broad Based Index,” the entire contents of which are hereby incorporated by reference.

### TECHNICAL FIELD

The present application relates in general to software and more specifically to methods and apparatus for producing a stock index.

### BACKGROUND

Existing stock indices include a predetermined number of stocks. For example, the S&P 500 includes 500 stocks, the DJI 30 includes 30 stocks, and the Russell 2000 includes 2000 stocks. There are several different ways to construct these indices. For example, the S&P 500 is a capitalization-weighted index. A cap-weighted index is constructed by share price multiplied by the number of outstanding shares. Then a predetermined number, for example 500, of the largest cap-weighted stocks are chosen to be included in the index.

Having a predetermined number of stocks included in a stock index is problematic for a number of reasons. When an index is tied to a definitive number of stocks, for example, the companies that may or may not be profitable are included in the index. In this regard, the index is not looking at the investment opportunity based on a fundamental analysis, it is based on a predetermined number e.g., 500 stocks in the S&P 500. Fundamentals such as earnings, sales growth, and business development and strategies, however, are important for investment purposes so that investors and financial institutions can use the index as a benchmark concerning a return on a portfolio.

Another downside to current stock indices is that no currently publicly traded or listed index applies a revenue growth estimate. More specifically, growth equities and emerging markets are typically excluded from current indices. For example, the high growth initial public offerings (IPOs) are excluded from current index calculations.

In addition, most indices do not include international stocks such as American Depository Receipts (“ADRs”) or American Depository Securities (“ADS”). This limits investment opportunity and diversification by forcing investors and institutions to buy the US market.

Finally AM settlements often times are problematic because investors, traders and institutions are exposed to overnight risk. For example, the overnight risk could include news releases, catastrophic events, and untold variables that expose investors to monetary risk that is not able to be hedged.

### SUMMARY

The presently disclosed system solves this problem by dynamically including the top X % of stocks based on float weighted capitalization in a new index. For example, the top 50% of stocks from a particular set of stocks (e.g., all of the stocks listed on a particular exchange) based on each stock's float weighted capitalization may be included in the index. As the overall list of stocks and/or the float weighted capitalizations change over time, the index may be automatically updated.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a process for producing the disclosed stock index.

FIG. 4 is an example of how the total float weighted capitalization may be determined for producing the disclosed index.

FIG. 5 is an example of a process to select and assign each of the securities from the total universe of listed securities

FIG. 6A is an example of the final selection process of the individual securities for the disclosed index.

FIG. 6B is another example of the final selection process of the individual securities for the disclosed index.

### DETAILED DESCRIPTION

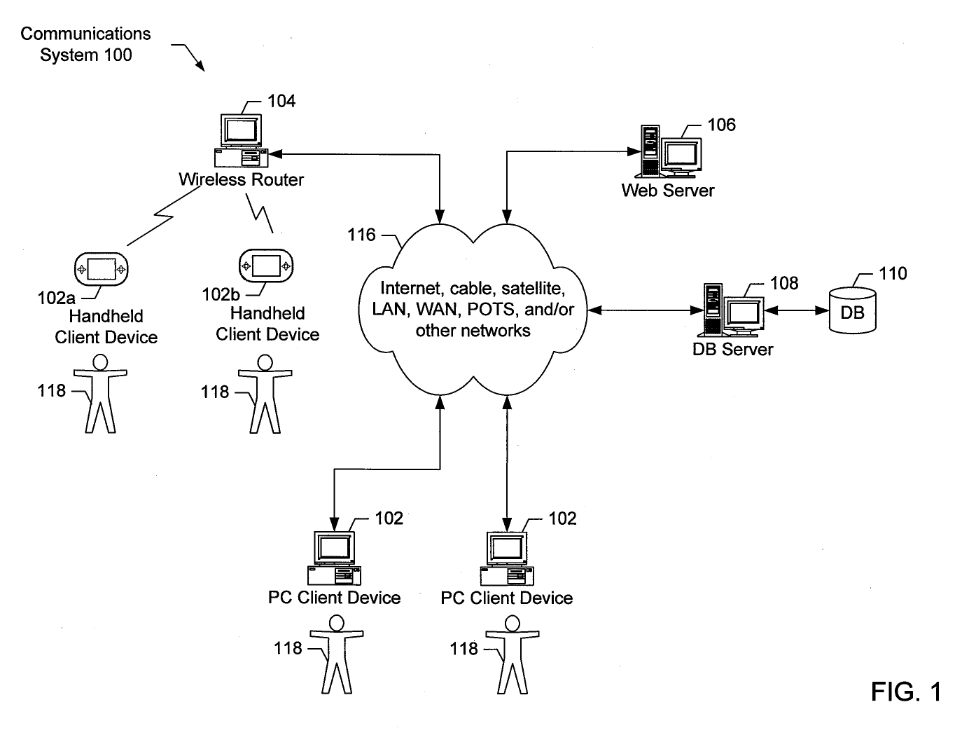

The disclosed system is most readily realized in a network communications system. A high level block diagram of an exemplary network communications system 100 is illustrated in FIG. 1. The illustrated system 100 includes one or more client devices 102, one or more wireless routers 104, one or more web servers 106, and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

One web server 106 may interact with a large number of client devices 102. Accordingly, each web server 106 is typically a high end computing device with a large storage capacity, one or more fast microprocessors, and one or more high speed network connections. Conversely, relative to a typical web server 106, each client device 102 typically includes less storage capacity, less processing power, and a slower network connection.

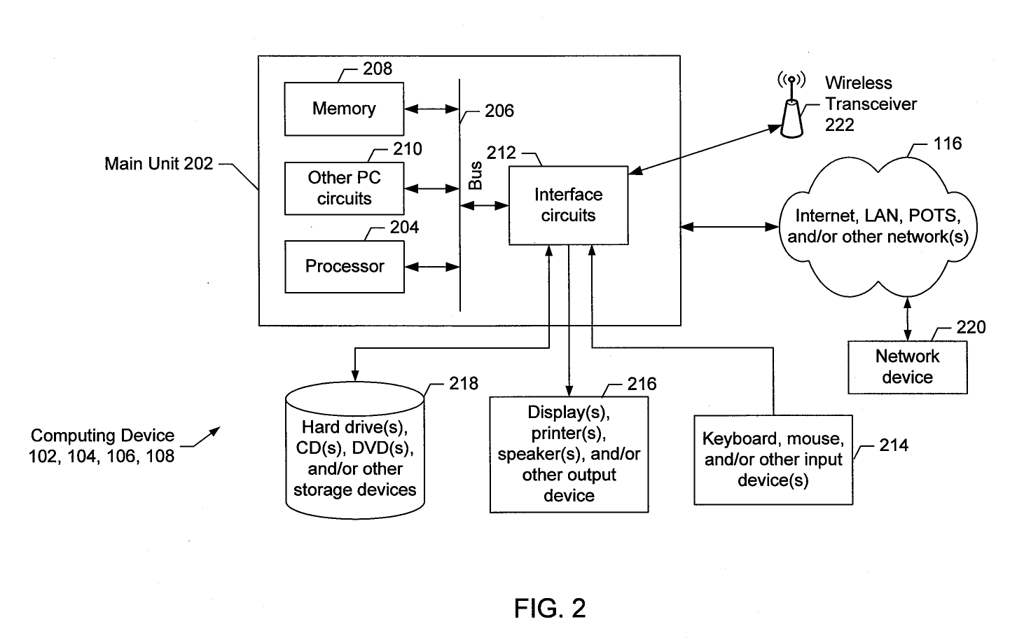

A detailed block diagram of an example computing device 102, 104, 106, 108 is illustrated in FIG. 2. Each computing device 102, 104, 106, 108 may include a server, a personal computer (PC), a personal digital assistant (PDA), a portable audio player, a portable audio/video player, a mobile telephone, and/or any other suitable computing device. Each computing device 102, 104, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions that interact with the other devices in the system 100 as described herein. These software instructions may be executed by the processor 204 in any suitable manner. The memory 208 and/or another storage device 218 may also store one or more data structures, digital data indicative of documents, files, programs, web pages, etc. retrieved from another computing device 102, 104, 106, 108 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 104, 106, 108. For example, the display 216 may be used to display web pages received from the web server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 104, 106, 108.

Each computing device 102, 104, 106, 108 may also exchange data with other computing devices 102, 104, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users of the system 100 may be required to register with the web server 106. In such an instance, each user may choose a user identifier (e.g., e-mail address) and a password which may be required for the activation of services. The user identifier and password may be passed across the communication channel(s) 116 using encryption built into the user's browser, software application, or device. Alternatively, the user identifier and/or password may be assigned by the web server 106.

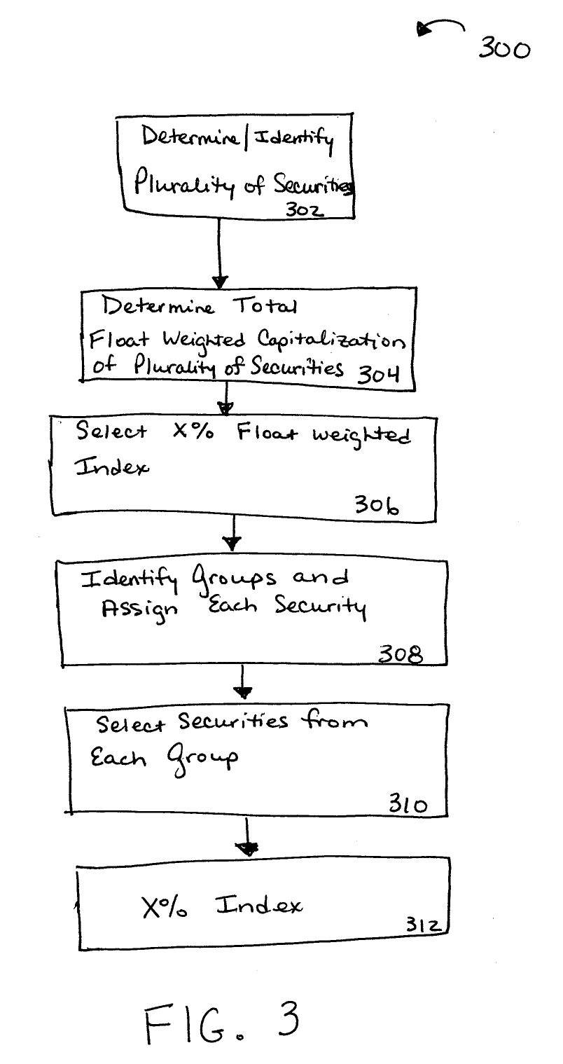

A flowchart of an example process 300 for producing a stock index is presented in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and some of the steps described may be optional.

In general, the process 300 identifies the float weighted capitalization of a listed stock market, and creates an index based on a top X percent of the total float weighted index. For example, the top 50% of stocks from a particular set of stocks (e.g., all of the stocks listed on a particular exchange) based on each stock's float weighted capitalization may be include in the index. As the overall list of stocks and/or the float weighted capitalizations change over time, the index may be automatically updated.

The process 300 begins with a review and identification of a plurality of securities (e.g., equities, stocks and ADRs) (block 302). The securities preferably are listed on a major securities exchange, such as the New York Stock Exchange, NASDAQ and the like.

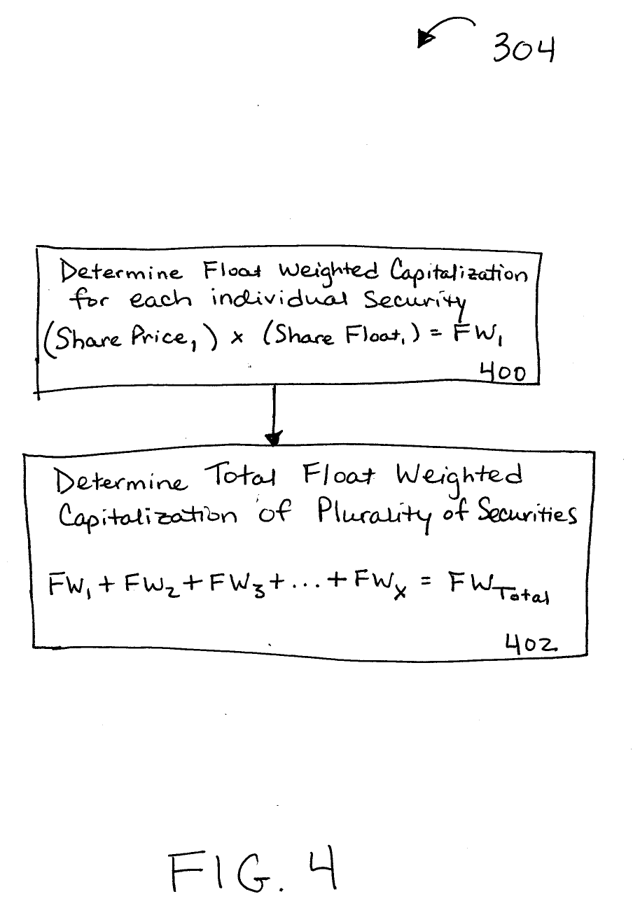

Next, the total float weighted capitalization of the plurality of securities (e.g., U.S. stock market) is determined (block 304). FIG. 4 is an example of how the total float weighted capitalization may be determined. More specifically, the share price of an individual security is multiplied by the share float for that security (block 400). The share float generally refers to all outstanding shares held by public investors and institutions but not held by the corporation. The result of this step (block 400) is the float weighted capitalization for the individual security (e.g., FW₁). Next, the float weighted capitalization for each security within the identified plurality of securities is determined and added together (block 402). The result is the total float weighted capitalization of the listed stock market (FW_{T}).

Next, the X % float weighted index is selected. In an embodiment, the X % is preferably a percentage between 50 and 70 percent, however, any percent may be selected (e.g., 30%, 40%, 75%) (block 306). The percentage selected for the X % may affect the broad based nature of the index including its flexibility and exposure. Although FIG. 3 shows X % is identified after the total float weighted capitalization of the plurality of listed securities is determined, the X % may be selected at any time in the process.

Next, the plurality of listed securities is reviewed and each of the securities is analyzed to determine whether it may be assigned to one of a number of groups (block 308). Each of the groups describes a particular industry sector. In an example, Group 1 includes domestic (or U.S.) securities and Group 2 includes international securities (block 308), however, any sector of industry may be included or excluded from a group. The international stocks, ADRs or ADS are traded in the US on the major stock exchanges. This gives US investors the ability to buy and sell these individual stocks. In this example, the ability to include, for example, international stocks in the X % index for trading allows further diversification within a portfolio. Diversification typically means that portfolios are not affected adversely by one microeconomic event. Diversification may be an advantage of the present X % index, for example, when including equities that are a part of a regional theme (e.g., Europe, China, India and Brazil).

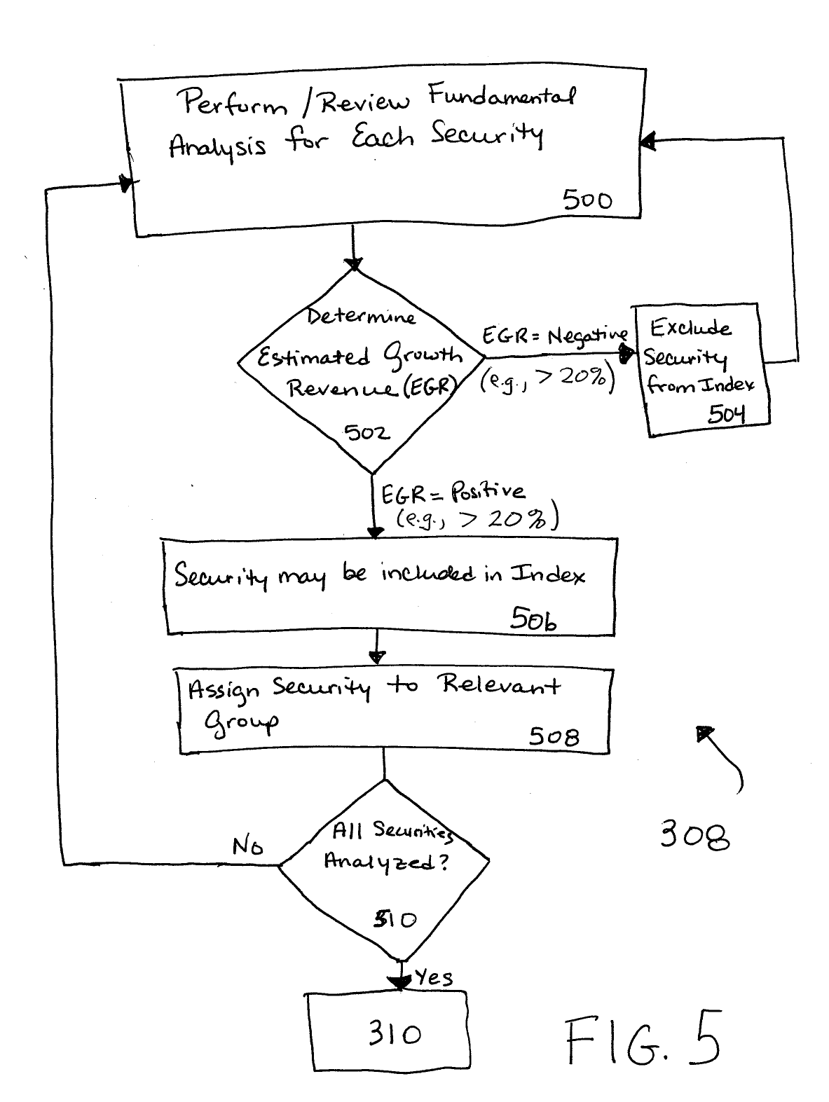

FIG. 5 describes an embodiment of the process for selecting and assigning each of the plurality of listed securities into groups (block 308). In an embodiment, a fundamental analysis is performed for each of the securities based on estimated revenue growth over a future period of time (e.g., two years) (block 500). The X % float weighted index may also take into account any suitable period (e.g., 1, 2 or 5 years) of revenue growth estimates from as few as one analyst to several independent analysts, depending on the size of the company's analyst coverage. Example fundamentals that may be analyzed include earnings, sales growth, and business development and strategies.

Next, the growth estimate is evaluated to determine if it is a negative growth or a positive growth (block 502). If a negative growth is estimated, then the security may be excluded from the index (blocks 502, 504). For example, if the negative growth is 20% or greater the security may be excluded because the negative growth may indicate company mismanagement, or a company's loss of competitive market position and pricing. If a positive growth is estimated, then the security may be included in the index (block 506). Positive growth estimate may, for example, be related to a company's release of a new technology. However, the new technology has not had enough time to garner true revenue and sales data. In this example, the positive growth estimate allows for the security to remain a possible security for ultimate selection within the X % index. The security is then assigned to its relevant group (e.g., Group 1 and Group 2 in the above example) (block 508). The float weight capitalization of each of the remaining stocks is considered for being included in the X % float weighted index. Once the assignment and/or exclusion of all the securities is complete, the selection of the individual securities from the groups for the X % index is initiated (block 310).

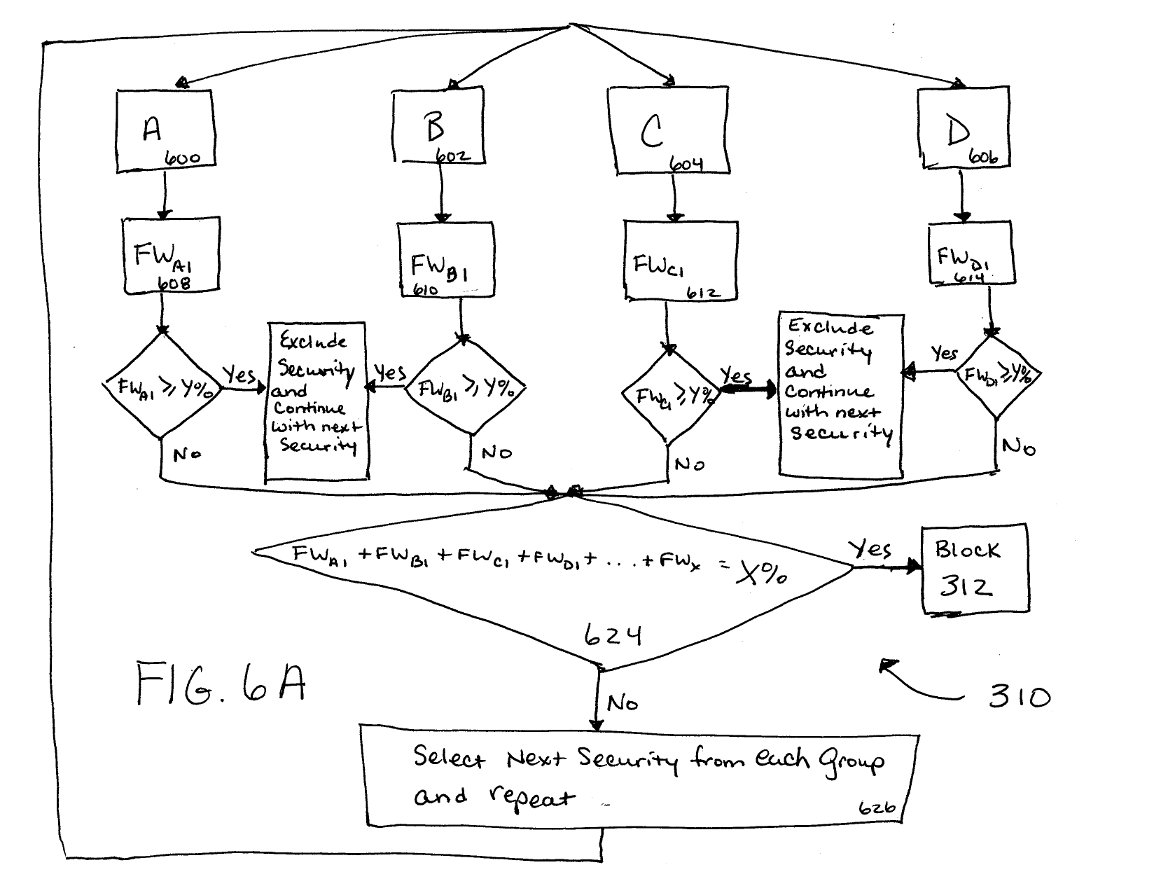

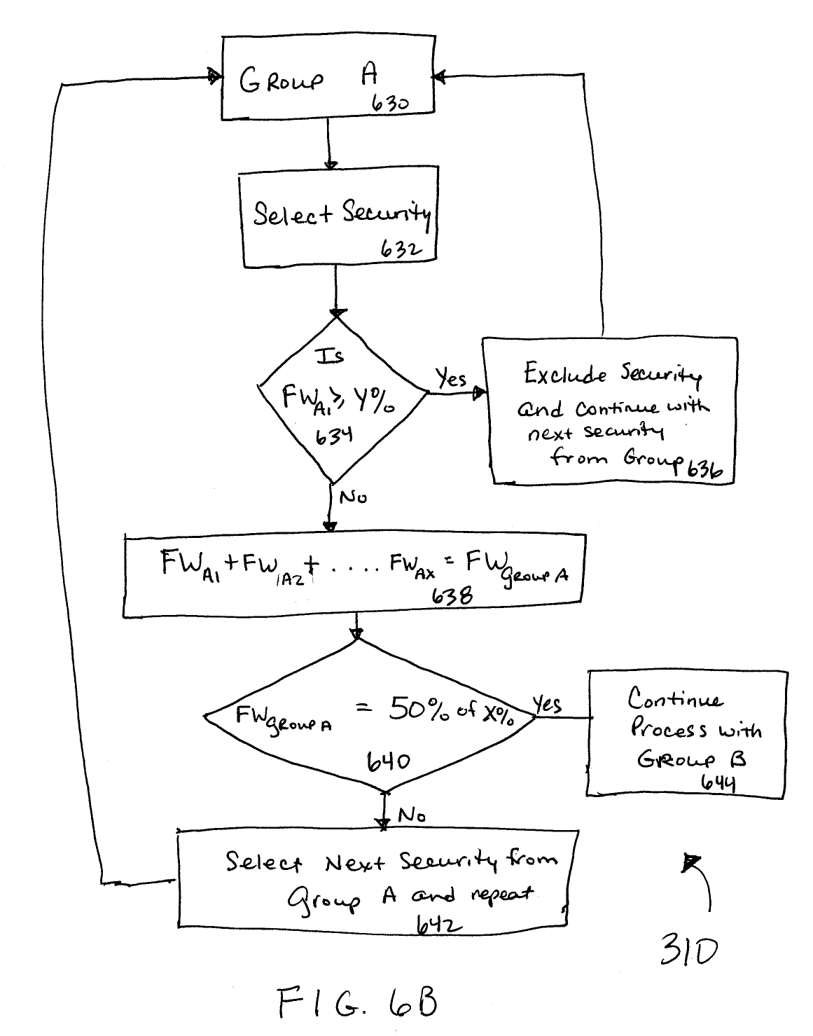

FIG. 6A shows an example of the final selection process of the individual securities in which equal representation by the number of securities from each group is desired. In this example, the securities have been assigned to one of four groups, Group A, Group B, Group C and Group D (blocks 600, 602, 604, 606). Next, the security preferably having the greatest float weighted capitalization within each Group is selected, e.g., FW_{A1}, FW_{B1}, FW_{C1}, FW_{D1} (blocks 608, 610, 612, 614). The float weighted capitalization is checked to determine whether it is Y % of the X % of the X % index (e.g., 4% or 5% of X %) or greater (blocks 616, 618, 620, 622). If the float weighted capitalization of an individual security is Y % or greater it may be excluded from being selected for the index because of the potential influence the one security may have on the pricing of the overall index. If the float weighted capitalization is less than Y %, the associated security is preferably included in the index. In FIG. 6A, for example, the float weighted capitalization for each of the securities is less than Y %. In this regard, the float weighted capitalization for each security is added together to determine whether the total float weighted capitalization for the selected securities has reached X % (block 624). If the X % has not been reached, the process is repeated in FIG. 6A (e.g., the next security is selected from each group and goes through the process) until the float weighted capitalization for the selected securities meets or slightly exceeds X % (block 626). Once X % is met or slightly exceeded, the securities that will make up the X % index have been identified (block 312). One of ordinary skill in the art would readily appreciate that any percentage close to the X % is within the scope and spirit of the disclosed process.

FIG. 6B shows another example of the final selection process of the individual securities in which an equal percentage of float weighted capitalization is selected from each group of securities. In an embodiment, the securities identified for the X % index will be selected from two Groups, e.g., Group A and Group B. The index includes 50% of the X % float weighted capitalization selected from the Group A securities and the remaining 50% are selected from Group B. One of ordinary skill in the art would readily appreciate that any percentage close to the target percentage (e.g., 50%) is within the scope and spirit of the disclosed process. There are a number of ways the securities may be selected from each group until the sum of the group is 50% of the X % float weighted capitalization (block 632). For example, securities from. Group A may be selected from the largest float weighted number in Group A, and the selection is continued in descending order. As stated earlier, it is preferable that no one individual security is more than Y % of the X % float weighted index (e.g., 4% or 5%) (block 634). If an individual security is Y % or greater it may be excluded from being selected for the index because of the potential influence the one security may have on the pricing of the overall index (block 636). The float weighted capitalization of each selected security is added together until the float weighted capitalization for the selected securities from the Group A is 50% of X % (blocks 638, 640, 642). The same calculation is repeated for Group B (644).

Once the securities are selected from the groups, the sum of the float weighted capitalization of the selected securities is X %. These securities are then listed on the X % float weighted capitalization index (block 312). An index price is set and ready to market. As the overall list of stocks and/or the float weighted capitalizations change over time, the index may be automatically updated.

In summary, persons of ordinary skill in the art will readily appreciate that methods and apparatus for producing a stock index have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of producing a top X % float weighted stock index, the method comprising:
identifying a plurality of securities;
determining a total float weighted capitalization of the, plurality of securities;
determining a target float weighted capitalization as a first predetermined percentage of the total float weighted capitalization;
selecting a first subset of the plurality of securities based on a first industry sector;
selecting a second different subset of the plurality of securities based on a second different industry sector;
determining a first plurality of float weighted capitalizations associated with the first subset of securities;
determining a second plurality of float weighted capitalizations associated with the second subset of securities;
selecting a first portion of the first subset of securities based on the first plurality of float weighted capitalizations, wherein the first portion of securities have a first subtotal float weighed capitalization;
selecting a second portion of the second subset of securities based on the second plurality of float weighted capitalizations, wherein the second portion of securities have a second subtotal float weighed capitalization, and the sum of the first subtotal and the second subtotal exceeds the target float weighted capitalization; and
listing the first portion of securities and the second portion of securities in the top X % float weighted stock index.

2. The method of claim 1, wherein the plurality of securities are listed on a single stock exchange.

3. The method of claim 1, wherein the plurality of securities are listed on a plurality of different stock exchanges.

4. The method of claim 1, wherein the first predetermined percentage is 50%.

5. The method of claim 1, wherein selecting the first subset of the plurality of securities is also based on an estimated revenue growth.

6. The method of claim 1, wherein selecting the first subset of the plurality of securities is excludes a stock associated with a negative estimated revenue growth.

7. The method of claim 1, wherein a particular security is excluded from selection if a float weighted capitalization of the particular security exceeds a second different predetermined percentage of the total float weighted capitalization.

8. The method of claim 1, wherein the first subtotal float weighed capitalization is equal to the second float weighed capitalization.

9. The method of claim 1, wherein the top X % float weighted stock index is periodically updated thereby changing the first portion of securities and the second portion of securities.

10. An apparatus for producing a top X % float weighted stock index, the apparatus comprising:
a processor;
an input device operatively coupled to the processor;
an output device operatively coupled to the processor; and
a memory device operatively coupled to the processor, the memory device storing instructions to cause the processor to:
identify a plurality of securities;
determine a total float weighted capitalization of the plurality of securities;
determine a target float weighted capitalization as a first predetermined percentage of the total float weighted capitalization;
select a first subset of the plurality of securities based on a first industry sector;
select a second different subset of the plurality of securities based on a second different industry sector;
determine a first plurality of float weighted capitalizations associated with the first subset of securities;
determine a second plurality of float weighted capitalizations associated with the second subset of securities;
select a first portion of the first subset of securities based on the first plurality of float weighted capitalizations, wherein the first portion of securities have a first subtotal float weighed capitalization;
select a second portion of the second subset of securities based on the second plurality of float weighted capitalizations, wherein the second portion of securities have a second subtotal float weighed capitalization, and the sum of the first subtotal and the second subtotal exceeds the target float weighted capitalization; and
list the first portion of securities and the second portion of securities in the top X % float weighted stock index.

11. The apparatus of claim 10, wherein the first predetermined percentage is 50%.

12. The apparatus of claim 10, wherein selecting the first subset of the plurality of securities is also based on an estimated revenue growth.

13. The apparatus of claim 10, wherein a particular security is excluded from selection if a float weighted capitalization of the particular security exceeds a second different predetermined percentage of the total float weighted capitalization.

14. The apparatus of claim 10, wherein the first subtotal float weighed capitalization is equal to the second float weighed capitalization.

15. The apparatus of claim 10, wherein the top X % float weighted stock index is periodically updated thereby changing the first portion of securities and the second portion of securities.

16. A computer readable memory device storing instructions to cause a computing device to:
identify a plurality of securities;
determine a total float weighted capitalization of the plurality of securities;
determine a target float weighted capitalization as a first predetermined percentage of the total float weighted capitalization;
select a first subset of the plurality of securities based on a first industry sector;
select a second different subset of the plurality of securities based on a second different industry sector;
determine a first plurality of float weighted capitalizations associated with the first subset of securities;
determine a second plurality of float weighted capitalizations associated with the second subset of securities;
select a first portion of the first subset of securities based on the first plurality of float weighted capitalizations, wherein the first portion of securities have a first subtotal float weighed capitalization;
select a second portion of the second subset of securities based on the second plurality of float weighted capitalizations, wherein the second portion of securities have a second subtotal float weighed capitalization, and the sum of the first subtotal and the second subtotal exceeds the target float weighted capitalization; and
list the first portion of securities and the second portion of securities in the top X % float weighted stock index.

17. The computer readable memory device of claim 16, wherein the first predetermined percentage is 50%.

18. The computer readable memory device of claim 16, wherein selecting the first subset of the plurality of securities is also based on an estimated revenue growth.

19. The computer readable memory device of claim 16, wherein a particular security is excluded from selection if a float weighted capitalization of the particular security exceeds a second different predetermined percentage of the total float weighted capitalization.

20. The computer readable memory device of claim 16, wherein the top X % float weighted stock index is periodically updated thereby changing the first portion of securities and the second portion of securities.
